(19) United States
(12) Patent Application Publication
(10) Pub. No.: US 2021/0337445 A1
(43) Pub. Date: Oct. 28, 2021

(54) GEO Fencing Enterprise Network with Macro Pilot Signature

(71) Applicant: Celona, Inc., Cupertino, CA (US)

(72) Inventor: Srinivasan Balasubramanian, San Diego, CA (US)

(21) Appl. No.: 17/237,914

(22) Filed: Apr. 22, 2021

Related U.S. Application Data
(60) Provisional application No. 63/014,108, filed on Apr. 22, 2020.
(60) Provisional application No. 63/173,294, filed on Apr. 9, 2021.

(51) Int. Cl. H04W 36/04; H04W 48/14; H04W 36/00

(52) U.S. Cl. CPC H04W 36/04; H04W 36/0061; H04W 48/14

(57) ABSTRACT

A low power, automated method and apparatus to determine when user equipment (UE) is near a private network that resides within the coverage area of an MNO network. Upon determining that the UE is near a private network, such as an enterprise network (EN), the UE may request a handover to an enterprise base station/access point (BS/AP), or otherwise transition to attach to the EN BS/AP. In addition, during the deployment of EN, information is stored in a cloud server. A smooth and low power determination that a UE that is authorized to attain service from the private network enables a transition from an MNO network to the private network.

### CLAIM OF PRIORITY TO PREVIOUSLY FILED PROVISIONAL APPLICATION—INCORPORATION BY REFERENCE

This application claims priority under 35 USC section 111 (b) and under 35 USC section 119 (e), to earlier-filed provisional application No. 63/014,108, filed Apr. 22, 2020, entitled “GEO Fencing Enterprise Network with Macro Pilot Signature” (ATTY DOCKET NO. CEL-025-PROV); and the contents of this earlier-filed provisional application (App. No.: 63/014,108) is hereby incorporated by reference herein as if set forth in full. This application also claims priority under 35 USC section 111 (b) and under 35 USC section 119 (e), to earlier-filed provisional application No. 63/173,294, filed Apr. 9, 2021, entitled “GEO Fencing Enterprise Network” (ATTY DOCKET NO. CEL-025-PROV-2); and the contents of this earlier-filed provisional application (App. No.: 63/173,294) is hereby incorporated by reference herein as if set forth in full.

### BACKGROUND

### (1) Technical Field

The disclosed method and apparatus generally relate to systems for selecting a communications network. In particular, the disclosed method and apparatus assist in determining when user equipment transition across mobile network operator (MNOs) networks and private enterprise networks (also referred to herein as “ENs”) based on information derived from the mobile network operators (MNO).

### (2) Background

FIG. 1 is an illustration of a basic configuration for a communication network, such as a “4G LTE” (fourth generation Long-Term Evolution) or “5G NR” (fifth generation New Radio) network, in which user equipment (UE) communicates with a base station/access point (BS/AP). The term UE refers to a wide array of devices having wireless connectivity, such as a cellular mobile phone, Internet of Things (IoT) devices, virtual reality googles, robotic device, autonomous driving machines, smart barcode scanners, and communications equipment, which includes cell phones, desktop computers, laptop computers, tablets and other types of personal communications devices. Throughout this disclosure, the term BS/AP is used broadly to include at least an extended NodeB (eNB) or gNB of an LTE/5G network, a cellular base station (BS), a Citizens Broadband Radio Service Device (CBSD), a WiFi access node, a Local Area Network (LAN) access point, a Wide Area Network (WAN) access point, etc. and should also be understood to include other network receiving hubs that provide wireless access by a plurality of wireless transceivers to a network.

In some cases, a UE 101 uses a BS/AP 103 to gain access to a network of other devices and services. 5G technology supports both public networks and private networks, such as cellular networks and enterprise networks. The BS/AP 103 is coupled to a core network 105 that provides management and connectivity to resources, such as the internet 107.

FIG. 2 is an illustration of a larger network, such as a 5G cellular network operated by a MNO, sometimes referred to as a wireless service provider. Within the geographic operating area of the MNO network, a private network may be established by a private network operator, such as an enterprise network operator (ENO). Private networks are operated for use by a limited group of authorized users, whereas public networks are open for use by anyone that subscribes to the service by the network operator. An enterprise network is one particular type of private network operated by an organization for use by the members of the organization. Other types of private networks may be operated by a private network manager for use by more than one organization. As shown in FIG. 2, BS/APs 103a of the MNO network may service a plurality of UEs (101 in FIG. 1, 102 in FIG. 2) that are present within the coverage area 204 of the MNO network on a first frequency f1. In addition, if a private network 208 is operated within the coverage area 204 of the MNO network, one or more EN BS/APs 103b may provide connectivity for UEs 102b that are present within the coverage area of the private network 208 on a second frequency f2.

Recently, the US Federal Government finalized rules for the use of an area of the frequency spectrum referred to as the Citizens Broadband Radio Service (CBRS). CBRS systems operate in a 150 MHz wide frequency range from 3.55 GHz to 3.7 GHz. In many cases, private networks are being established in accordance with 5G specifications using CBRS bands.

In cellular communication systems, such as 4G LTE and 5G NR networks, the BS/APs 103 operated by each MNO transmit a unique identifier as part of their wireless transmission. This unique identifier is called a Cell Identifier (ID). The Cell ID identifies the BS/AP 103 that is transmitting the Cell ID, and thus provides a means for identifying the cell providing the cellular communications service for the geographic area.

In cases in which an enterprise network is formed within the geographic coverage area of an MNO network, an enterprise campus may be defined as the area over which the enterprise network provides service. The enterprise campus may be bounded by a “GEOFENCE”. The GEOFENCE maintains a well-defined boundary within which UE's 102 can take advantage of the enterprise network's services. The GEOFENCE also allows UEs 102 to appropriately transition between an MNO network and the enterprise network as the UE 102 enters and exits the enterprise campus. That is, when a UE 102 moves through the coverage area 204 of the MNO network, it may be helpful to determine when the UE 102 has entered the enterprise network 208. In some cases, a global positioning system (GPS) based fencing can be used, but may require a significant amount of power to be consumed by the UE 102, given that the standalone GPS fix typically takes well over 15 times the power needed to scan when looking for available 4G/5G service.

The GPS location marked at the BS/AP 103b of the enterprise network during deployment does not take into account the actual area covered by the Enterprise network, nor area covered by the MNO network. Therefore, these points may not be directly applicable to determining the appropriate transition points between the two networks.

Accordingly, there is a need for a low power, automated method and apparatus to define the perimeter of a private network that resides within the coverage area of an MNO network. In some cases, it would be advantageous to do so during the deployment of the EN BS/APs 103b that provide enterprise network service for the UEs 102b. Furthermore, there is a need for a smooth and low power determination that a UE 102 that is authorized to attain service from a private network should transition from an MNO network to the private network.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is an illustration of a basic configuration for a communication network in which user equipment (UE) communicates with network provided services through a base station/access point (BS/AP).

FIG. 2 is an illustration of a private network located within the coverage area of a larger network.

FIG. 3 is a simplified illustration of the apparatus used in some embodiments of the disclosed method and apparatus.

FIG. 4 is a flowchart of the process used by a UE in accordance with one embodiment of the disclosed method and apparatus.

FIG. 5A shows modeling of a coverage area of an EN using a set of points on an ellipsoid with uncertainty circles identifying boundaries of the EN coverage area.

FIG. 5B shows modeling of a coverage area of an EN using a polygon with a set of connected points at particular GPS coordinates, the points in sequence connecting back to an initial point to establish boundaries of the EN campus.

FIG. 5C shows a set of overlapping cells based upon MNO network coverage areas.

FIG. 5D shows a set of MNO network coverage areas and threshold RSRP (reference signal received power) ranges associated with each MNO BS/AP with which the UE may communicate.

FIG. 6 shows one embodiment of an EN Identifier that may be used to practice the present method and apparatus.

FIG. 7 shows an example of an enterprise database high level schema supporting EN GEOFENCING information.

FIG. 8 shows a Cloud based server that can be used to practice the present methods and apparatus in accordance with the present disclosure.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

The disclosed method and apparatus provide an efficient and effective way to establish a GEOFENCE that defines the coverage area (i.e., “campus”) of a private network, such as an enterprise network (hereafter, “EN”). In addition, the disclosed method and apparatus provides an efficient and effective way to determine when user equipment (UE) should transition from a Mobile Network Operator (MNO) network to a private network. The term UE refers to a wide array of devices having wireless connectivity, such as a cellular mobile phone, Internet of Things (IoT) devices, virtual reality googles, robotic device, autonomous driving machines, smart barcode scanners, and communications equipment, which includes cell phones, desktop computers, laptop computers, tablets and other types of personal communications devices.

In accordance with some embodiments, each of the entries in an equivalent home public land mobile network (EHPLMN) is associated with a specific GEOFENCING entity. A GEOFENCING entity is a geographic boundary. In some cases, the GEOFENCING entity defines the enterprise campus (hereafter, “EN campus”) within which a UE can attain service through an enterprise network. In some embodiments, the GEOFENCING is used for both entering and leaving the enterprise network.

The use of independent GEOFENCING services allows a higher level definition to be established for the service area of an individual enterprise deployment. GEOFENCING allows an enterprise network deployment to be more flexibly defined, and to independently learn and manage the desired GEOFENCEs that geographically define the network deployments as the network grows and changes.

In some embodiments, the GEOFENCING features can be applied to a CSG/NHN-ID (closed subscriber group/neutral host ID) based system. For example, scans for networks in a CSG/NHN-ID system can be based on whether a UE is inside or outside a GEOFENCE that is associated with the network for which the UE is scanning. In some embodiments, the network is associated with a PLMN or other identifying code.

In addition, in some embodiments, changes to the priority level of each PLMN within a prioritized list of PLMNs, such as the EHPLMN list, can be made based on the particular geographic location of a UE. In some such embodiments, the location of the UE 102 is determined by whether the UE 102 is inside or outside a particular GEOFENCE. Accordingly, the priority order of PLMNs within the particular prioritized lists in a UE 102 may be dependent upon the GEOFENCE in which the UE is presently located.

In some embodiments, UEs may have subscriptions to one or more MNO networks (i.e., they may have one or more credentials allowing access various MNO networks). Typically, a selected UE has only one subscription to, and credentials for communicating within, a single MNO (for example, an MNO such as Verizon, Sprint, etc.). nonetheless, in some embodiments, the selected UE may have subscriptions to, and credentials allowing communications using, more than one MNO network. In some embodiments, UEs also have credentials to communicate with, and have authorization to access, one or more Enterprise Networks (“ENs). In some embodiments, a selected UE scans for the presence of a preferred EN only when the UE is near the preferred EN. This alleviates a need for the UE to expend power and processing resources unnecessarily by scanning for the existence of a preferred EN when such EN is not in range. UEs do not scan for such preferred ENs when they are not in sufficiently close to the preferred ENs.

This scanning approach avoids having the UEs unnecessarily scan for other ENs, even when the UEs is near the other ENs (i.e., the “other ENs” that are not one of the preferred ENs). Consequently, in some embodiments, the UE saves considerable battery power and processing resources.

Using a simplistic approach as an example, UEs may be designed to scan for a selected EN once every pre-determined time period (for example, once every 15 minutes). Obviously, the time period that a selected UE uses to scan for a preferred EN may vary with the design requirements set forth by the network designers. Other scanning techniques may also be used.

### ENTERPRISE NETWORK GEOFENCE DEFINITION

Initially, when an EN is deployed, the GEOFENCE of the EN is defined as part of the deployment process. In some embodiments of the disclosed method and apparatus, the extremities of the campus are marked using a smartphone application to allow those tasked with implementing the deployment to walk to specific corners and mark “entry points” into the enterprise campus. This can be accomplished using one or more “survey cellular phones” (or survey UEs). In some embodiments, a single survey phone may have sufficient “credentials” to allow registration with each of the MNO networks (such as Verizon Wireless, ATT, T-Mobile, etc.) providing coverage over a portion of the enterprise campus in which the private network is to be deployed. Even with this, a survey phone may not capture all frequencies/technologies from which a UE 102 can transition into the private network, but having the ability to register with several MNO networks will allow important information to be attained that can assist with the procedures for defining the boundaries of the private network. Using such a survey phone allows measurements of MNO network signals to be captured.

Furthermore, in some embodiments, the survey phone may provide GPS information with the radio signal measurements. The collected information may used to form signal signatures, in some embodiments. Such signatures can be generated based on the particular set of Cell-IDs that can be received from one or more of the MNO networks operating in the area. This information can be supplemented by additional measurements of the amount of power with which the signals on which the Cell-IDs are transmitted were received and any other relevant information that can assist in uniquely identifying the particular pattern of received signals associated with particular locations near the outside and inside and along the boundaries of an EN GEOFENCE that defines (in some embodiments, roughly) the campus. In addition, information can also be collected and maintained for many of the points in the interior of the EN campus. Once signatures are generated (in some embodiments, during the deployment of the enterprise network), the generated signatures can be stored in a cloud based server. The cloud based server can be accessed by a UE to allow the UE to determine whether the UE is near the EN campus. That is, upon receiving the signature from the cloud based server, a UE can generate a local signature based on the signals that the UE is receiving and compare that local signature to the signature received from the cloud based server. Alternatively, the cloud based server maintains sufficient information from which the signature can be generated. The UE then receives the information maintained in the cloud based server and generates the predetermined signature from the information received from the cloud based server. That predetermined signature is compared to the locally generated signature (i.e., the signature generated from the information received directly from the MNO network BS/APs by the UE). In some embodiments, such signatures are only maintained for points that are sufficient close to a EN that the UE will be able to successfully register with the EN upon being able to receive signals that can be used to generate the same signature. In some such embodiments, the UE requests the signature information based on the particular EN with which the UE would like to register.

Locations at which a selected UE should start looking for (or scanning for) the EN should be chosen as the points at which such information is to be collected by such a survey phone. While it is not essential that these points coincident with the physical entry and exit points of the enterprise campus, emphasis on those entry/exit points may be of value in some embodiments.

### OBTAINING GEOFENCING DATA WITHOUT USE OF A SURVEY UE

In some embodiments, a survey UE is not used to ascertain the MNO based measurements, GPS positions and/or radio signal measurements used to assist in defining the extremities of the EN coverage area and the parameters of the EN GEOFENCE. Rather, in accordance with some embodiments, each EN includes one or more EN base station/access points (BS/APs) that have associated and corresponding UEs (or cell phones that are associated with and correspond to the EN BS/APs). Throughout this disclosure, the term BS/AP is used broadly to include at least an extended NodeB (eNB) or gNB of an LTE/5G network, a cellular base station (BS), a Citizens Broadband Radio Service Device (CBSD), a WiFi access node, a Local Area Network (LAN) access point, a Wide Area Network (WAN) access point, etc. and should also be understood to include other network receiving hubs that provide wireless access by a plurality of wireless transceivers to a network. The methods described above for obtaining the EN GEOFENCE information may be optionally augmented and refined during deployment of the EN using the BS/AP associated UEs. In accordance with this embodiment, the BS/AP associated UEs are physically co-located with their associated and corresponding EN BS/APs (i.e., each BS/AP associated UE is physically co-located with the associated EN BS/AP).

In these embodiments, the BS/AP associated UEs use a software application that is downloaded thereon, wherein the software application, or “app”, is used to obtain the EN GEOFENCE data. In accordance with this embodiment, the BS/AP associated UEs “walk” through all of the frequencies of the MNO network and thereby ascertain measurements that can assist with defining the EN campus (i.e., the boundaries of the EN GEOFENCE). The BS/AP associated UEs are powered devices (that is, they are powered by an AC or DC power source and therefore do not rely on battery power) and therefore, power drain is not of concern for purposes of defining the EN GEOFENCE. In some embodiments, each EN BS/AP includes a mobile station modem (MSM). Similar to the manner in which the survey UE is used to define the EN GEOFENCE, the BS/AP associated UEs may obtain the radio signal characteristics, CellID information and other data associated with the MNO BS/APs with which the BS/AP associated UEs can establish communications. The BS/AP associated UEs also have GPS information associated with the GPS position of the EN BS/APs with which it is collocated. This information may also be used to define the EN GEOFENCE in some embodiments.

In some embodiments, this approach may be used together with the survey UE. Alternatively, no survey UE is used. As with the survey UE approach, a cloud based server has a database stored therein (hereafter referred to as a “cloud based database”) that is populated with the data obtained from the BS/AP associated UE. In some embodiments, the information in the cloud based database may be pushed onto a UE local memory.

The BS/AP associated UE may also collect signal measurements from neighboring MNO BS/APs at all frequencies on which such BS/APs are transmitting. According to this technique, the extremities of the EN campus can be marked more precisely by obtaining the radio signal characteristics received by the BS/AP associated UEs and storing this information in the cloud based database that eventually can be pushed to user UEs local memories.

### CROWD-SOURCED TECHNIQUE

In some embodiments, a crowd-sourced approach may be used to ascertain the parameters of the EN GEOFENCE. That is, in a crowd-sourced embodiment, not all of the cellular phones used need to have an application loaded thereon in order to determine the EN GEOFENCE. Rather, some of the survey data can be taken by a specific population of user UEs when the UEs enter or exit the EN campus. Once the EN is deployed, periodic “learning” of the conditions around the periphery of the EN can be performed using such crowd-sourced methods, such that any changes in the EN can be accurately captured. Typically, such changes will occur infrequently.

Some embodiments can be based on a set of cell-ID (i.e., the identification information associated with each cell of an MNO network) being seen by the survey phone (i.e., the active/candidate set). In some embodiments, a single device has multiple credentials, such that it will capable of identifying the MNO network Cell-ID information from BS/APs 103 of each MNO network that has cell sites transmitting at a signal level that is within a predetermined range, as received by the survey phone.

A generic device can be used that will perform a full scan (manual scan) of available systems and extract broadcast messages (i.e., those messages transmitted by the BS/APs 103 of one or more of the MNO networks operating in the area that can be received by all of the UEs 102). In some embodiments, a list of cell IDs of neighboring cells within the MNO network may be available through the network that the survey phone is camped on (i.e., the BS/AP 103 from which the UE 102 is receiving service). In some cases, these are hidden by the modem layers, except for the currently camped Cell ID information. Nonetheless, in some embodiments, a unique query through the BS/AP 103 may be transmitted from the UE 102 to request that the BS/AP 103 provide such information that would otherwise be unavailable. Upon receipt, such information will be to stored in the cloud based database and made available to the UE 102 based on the UE subscription. In some embodiments, information stored in the cloud based database is used to generate a signature that can be used by a UE to determine whether to start scanning for an EN BS/AP.

In some embodiments, GPS information is used opportunistically when the UE 102 has GPS otherwise enabled (i.e., not for purposes of defining an EN GEOFENCE) and position location information is determined in response to other software applications.

### MANAGED NETWORKS

In some embodiments, the disclosed EN GEOFENCE method and apparatus functions within “managed cellular networks”. In accordance with such embodiments, each EN has an associated and corresponding EN identifier, or Network Identifier (NID). The NID is issued by the CBRS alliance for private networks operating in the CBRS frequency band. The EN NID essentially provides a “passport” or access to employees or other organizational users using their user UEs. The EN NIDs allow the user UEs to access services provided by the EN that is identified by the EN NID. In such embodiments, the functionality of the user UEs is tightly controlled or managed. In accordance with some embodiments of the disclosed method and apparatus, the UEs have certain predetermined or previously “installed” characteristics, including but not limited to having credentials or “subscriptions” to certain specified or preferred ENs, within which the UEs can access services provided by the preferred ENs. Therefore, in such embodiments, the user UEs “know” the NIDs of the preferred ENs that the UEs prefer to and have authorization to communicate with (stated differently, the UEs have the NIDs of their preferred ENs stored in memory in the UEs).

### ENTERPRISE NETWORK GEOFENCE INFORMATION; CLOUD BASED DATABASE AND USER EQUIPMENT MEMORY

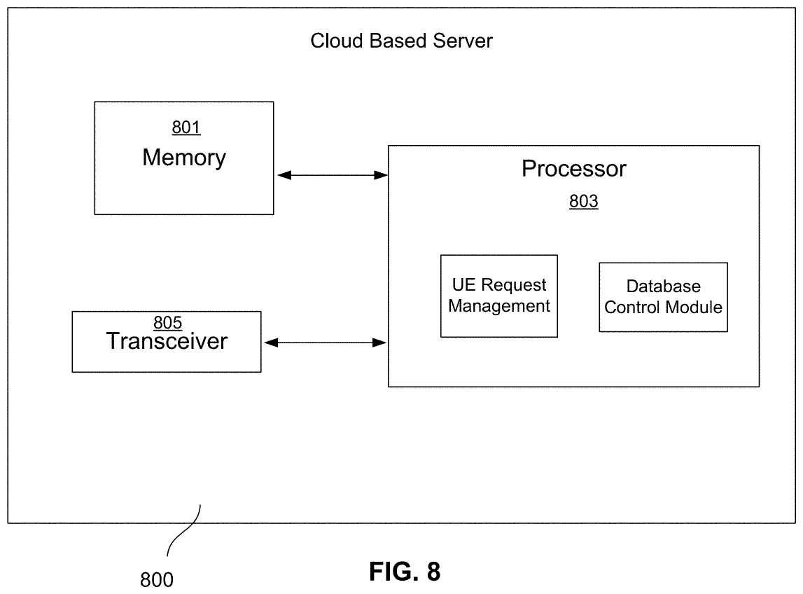

In some embodiments, the EN GEOFENCE information collected through the deployment survey procedures is stored in a database within a server, such as a cloud based server. One example of the contents of a database maintained in a server is described below in more detail with reference to FIG. 8. In some embodiments, the information stored in such a database is accessed through the key-based NID. As described above, each CBRS network is assigned a unique NID by the alliance. In some such embodiments, further classification can be required for distributed campuses within a NID. In some such embodiments, this can be managed based on GPS location. In some embodiments, the EN GEOFENCE information can be accessed using only the NID (that is, the GPS location information is not always required to access the EN GEOFENCE data). In some embodiments, information received and stored in the database may include MNO BS/AP information, including such information as cell ID, associated GPS location, operating frequencies, etc. This GEOFENCE information is associated with each EN NID (and possibly GPS location information).

For each MNO network, the information may include the Cell IDs of BS/APs near the enterprise campus. In addition, the reference signal received power (RSRP) values of one or more of the active and candidate MNO BS/AP radio signatures can be used to locate entry points into the EN campus. In some embodiments, the individual signatures are maintained independently to allow multiple entry points into the EN campus to be uniquely identified. In the case in which GPS information is associated with each of these radio signatures, the GPS information, if provided, is also maintained.

In some embodiments, the UE maintains the EN GEOFENCE information for its preferred EN in local memory, such as in a static RAM included in the UE. In these embodiments, the EN GEOFENCE information may be “pushed” or transmitted to the UE in a predetermined manner and with a predetermined update frequency. In some embodiments, this EN GEOFENCE data is pushed onto the UE local memory by the MNO BS/APs and/or by the EN BS/APs. The EN GEOFENCE data in the UE local memory is reflective of the EN GEOFENCE information stored in the cloud based database. As noted above, the UE accesses the EN GEOFENCE data contained in the cloud based database and/or in the UE local memory using the NID of the EN that is preferred by the UE. The UE can also use GPS positioning information in addition to the NID to access the EN GEOFENCE data, but this is not always required in some embodiments. The NID is used to identify the preferred EN that the UE has access to and is authorized to communicate with.

It should be noted that the NID may identify several ENs that are geographically located away from each other. For example, the preferred EN campuses identified by the NID may be located in different parts of a city, state, country or countries. Even though the preferred ENs are located in different parts of the world, they all share the same identical NID in some embodiments. In other embodiments, the UEs are provisioned to operate in only one part of the world and therefore, even though there are several physically distinct EN campuses all sharing identical NIDs, the UE scans only for the one preferred EN that it is configured to communicate with. In these embodiments, only the EN GEOFENCE data for the EN that the UE is configured to communicate with is pushed onto the UE's local memory. All other EN GEOFENCE data is not pushed onto the UE's local memory. Whether a particular embodiment has this function is dependent upon the EN system designers and network specifications.

### DEFINE OF ENTERPRISE NETWORK GEOFENCE

Alternative or additional techniques can be used to define a GEOFENCE for a selected EN. In one such embodiment, there are several features that can be enabled by associating the different EN deployments with a GEOFENCED area for both the network and the UE.

Employing GEOFENCED areas allows the UEs to perform power optimized scans when searching for specific enterprise campus networks.

From a network perspective, it primarily allows for better management of common address spaces that can potentially conflict with other EN deployments. This problem is inherent for LTE private network deployments employing the SHNI and obtaining IBNs, ECGI, GUMMEI, and TAIs. Even with the regulation, misuse can happen intentionally or unintentionally. This becomes less of an issue with a GEOFENCED approach and when the UE inherently avoids regions where it does not need to look for ENs.

In some embodiments, EN campuses vary in size and can require a coarse GEOFENCING, covering a large area, or potentially require building level GEOFENCING to allow UEs to determine their proximity to a preferred ENs. Using GPS-based GEOFENCING alone can have power consumption implications on the UE side and hence other methods such as MNO network Coverage areas can be used. The GPS locations of the EN BS/APs obtained during deployment of the EN allows for determining a rough coverage of the campuses, but do not directly translate to the actual coverage area of the EN.

In some embodiments, mechanisms are provided for UEs to use in order to identify the EIS server associated with the individual stored credentials and retrieve GEOFENCING information. The EN GEOFENCING data can optionally be delivered to the selected UE using alternative methods that are described herein.

### GEOFENCING INFORMATION

The GEOFENCING information may, in some embodiments, be specified as GPS information and/or Coverage area information.

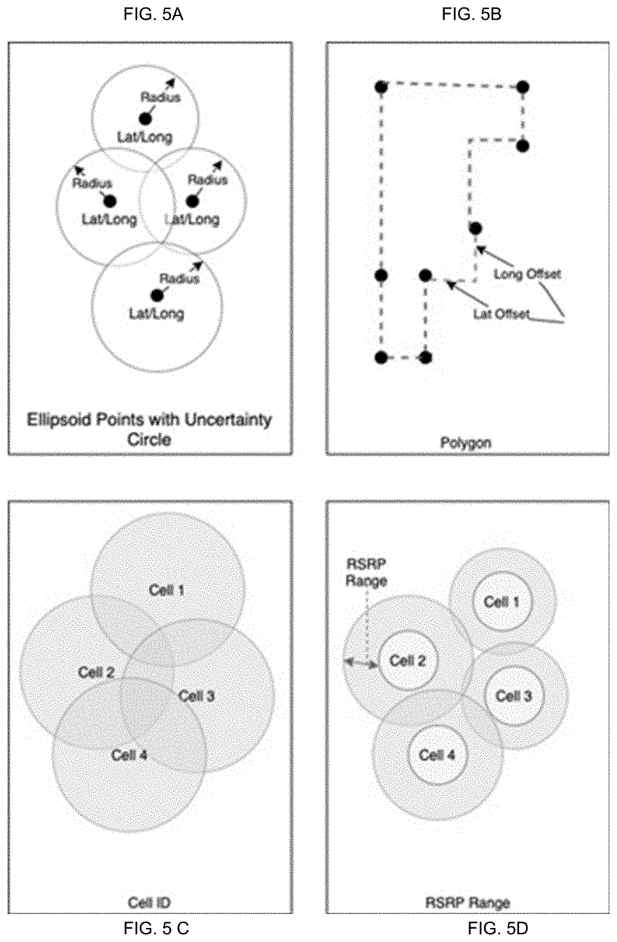

In embodiments in which GPS information is used, the definition of the GEOFENCE boundaries may be based on the geographical shapes shown in FIGS. 5A through 5D.

FIG. 5A shows a set of points on an ellipsoid with uncertainty circles identifying boundaries of the EN coverage area.

FIG. 5B shows a polygon with a set of connected points at particular GPS coordinates, the points in sequence connecting back to an initial point to establish boundaries of the EN campus.

FIG. 5C shows a set of overlapping cells based upon the MNO network coverage areas.

The MNO network coverage area information is specified based on:

a. a set of MNO BS/AP Cell-IDs (“macro cells”) indicating a potential availability of an EN when the selected UE enters these macro cells (that is, when the selected UE is in communication with one of the MNO BS/APs and is aware of the existence of neighboring MNO BS/APs); and
b. a set of MNO BS/AP Cell-IDs together with their associated signal strengths, which allows for finer control of the locations where the UE should start looking for the preferred EN campus.

FIG. 5D shows a set of MNO network coverage areas and threshold reference signal received power (“RSRP”) ranges associated with each MNO BS/AP. In some embodiments, the use of the threshold RSRP values prevents a selected UE from rapidly engaging communication with and then rapidly disengaging communication from a selected EN (i.e., from “ping-ponging” between engaging and disengaging with the EN BS/APs). The UE is only allowed to initiate scans for the preferred EN if it is within range of the preferred EN and if its RSRP values exceed a predetermined threshold value.

### ENTERPRISE INFORMATION FORMAT

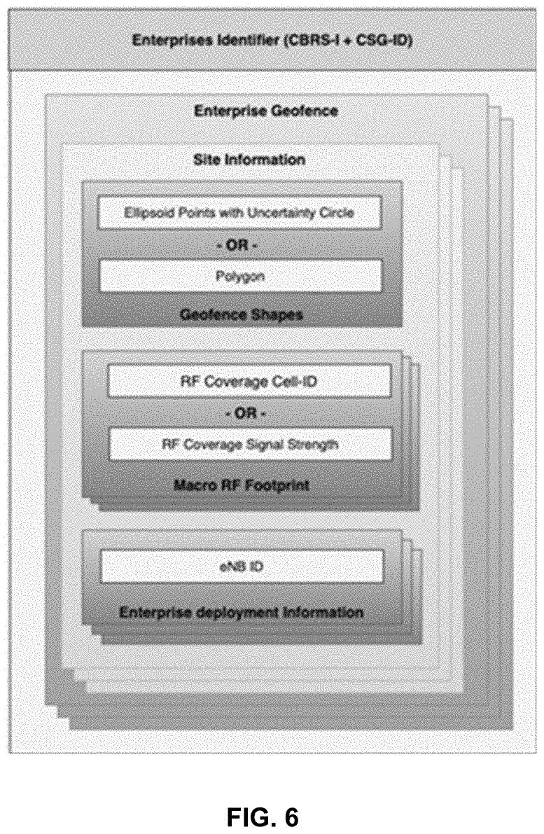

FIG. 6 shows one embodiment of an Enterprise Network Identifier that may be used to practice the present method and apparatus. It will be apparent to those skilled in the cellular communications arts that many different types of Enterprise Network Identifiers can be used to practice the present method and apparatus, and that the identifier shown in FIG. 6 is an example only and does not limit the scope of the appended claims.

The example format of the EN information associated with a selected Enterprise Network is described with reference to FIG. 6. The information shown in FIG. 6 may be provided to a selected UE. The selected UE can use this information for specific optimization for finding and “camping” onto Enterprise Networks. As shown in FIG. 6, the enterprise information could, in some embodiments, at least include EN GEOFENCING information. FIG. 6 provides a pictorial representation of the enterprise information format that is carried in a response message showing a nested structure. In some embodiments, the enterprise information is encoded as information associated with each enterprise identifier providing one or more EN GEOFENCE information.

Associated with each EN GEOFENCE, one or more sites are specified, and for each site, an EN GEOFENCE shape is provided. Additionally, and optionally, as shown in FIG. 6, the macro coverage area (and associated MNO network coverage areas and associated MNO network RSRP values) and Enterprise deployment information may also be provided to the UE.

The geographical shape information about a selected EN (site), shown and described above with reference to FIG. 5, may be included in the EN GEOFENCE information shown in FIG. 6 and is created during deployment of the EN. In some embodiments, the GPS positions of the EN BS/APs are determined when the EN is deployed. This GPS position information may be used to determine the geographical shape information shown in FIGS. 5A and 5B. This information may also be used to determine a geographical “center” of a selected EN campus and a rough estimate radius about the determined “center”. In this manner, geographical shape information (such as the examples of geographical shapes shown in FIGS. 5A and 5B) may be determined for a selected EN. In this manner, the GPS extremities of selected EN campus can be determined and used to create the EN GEOFENCING data shown in the Identifier of FIG. 6, and stored in the cloud based database, and possibly pushed to the EN UEs that have authorization to engage with the selected EN.

### ENTERPRISE NETWORK DATABASE HIGH LEVEL SCHEMA

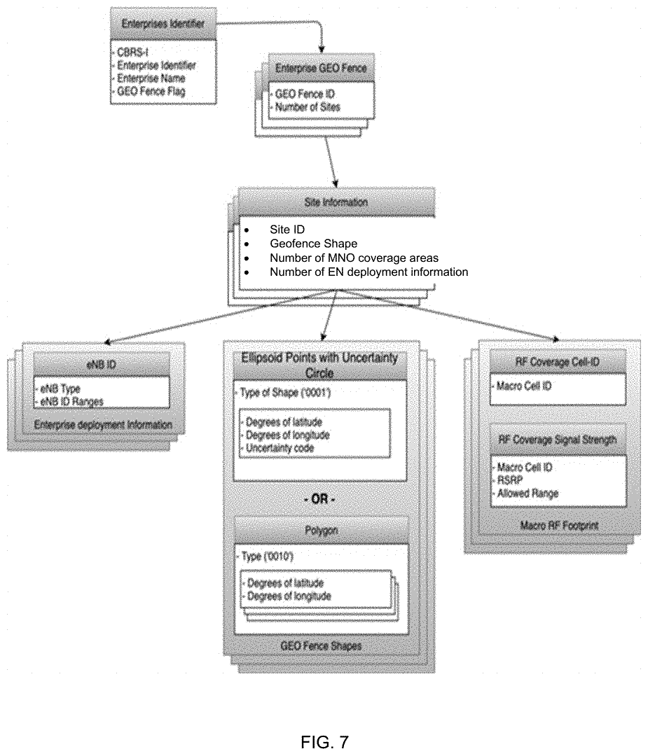

FIG. 7 shows an example of an enterprise database high level schema supporting EN GEOFENCING information. The database is structured to allow for multiple GEOFENCE areas to be specified per enterprise network. Multiple sites can be specified within each instance of an EN GEOFENCE. Associated with each site, one or more of the GEOFENCE information is accommodated. The EN GEOFENCE information can be specified as geo-shapes information as described above with reference to FIG. 5, and as MNO network coverage area information based on, for example, MNO network coverage information and Enterprise RF deployment information.

As described above with reference to FIG. 5, in some embodiments, the geolocation information can be specified as a ‘Ellipsoid Points with Uncertainty Circle’ or as a ‘Polygon’. In some embodiments, information regarding the coverage area can be specified using the ‘Cell-ID’ and measurements of the strength of signals transmitted from the BS/AP associated with the Cell-ID (i.e., ‘signal strength’ values). The Cell-IDs are those that are transmitted by BS/APs near the EN campus. One or more of the RSRP values of the active and candidate MNO Cell-IDs (i.e., one or more of the MNO BS/APs Cell-IDs) can be used to determine entry and exit points into and out of the EN campus. Note that the individual signatures are retained independently to allow multiple entry points into the EN campus to be recognized. Also, as stated in the above-incorporated CBRS standard, in some embodiments, the enterprise RF deployment information is specified providing the type of eNB (EN BS/AP) (indoor and outdoor) and the eNB (EN BS/AP) identifiers.

### SCANING FOR A PRFERRED ENTERPRISE NETWORK

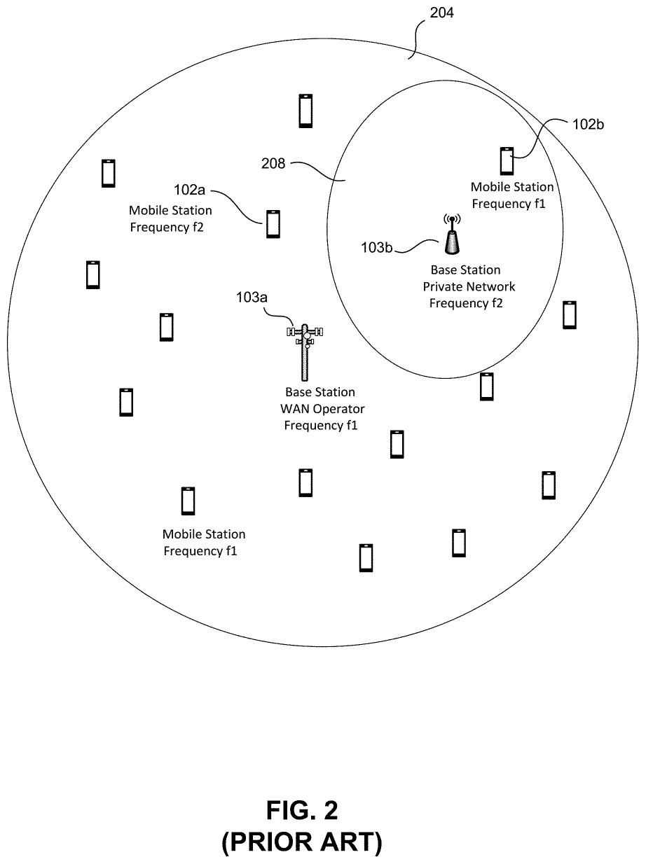

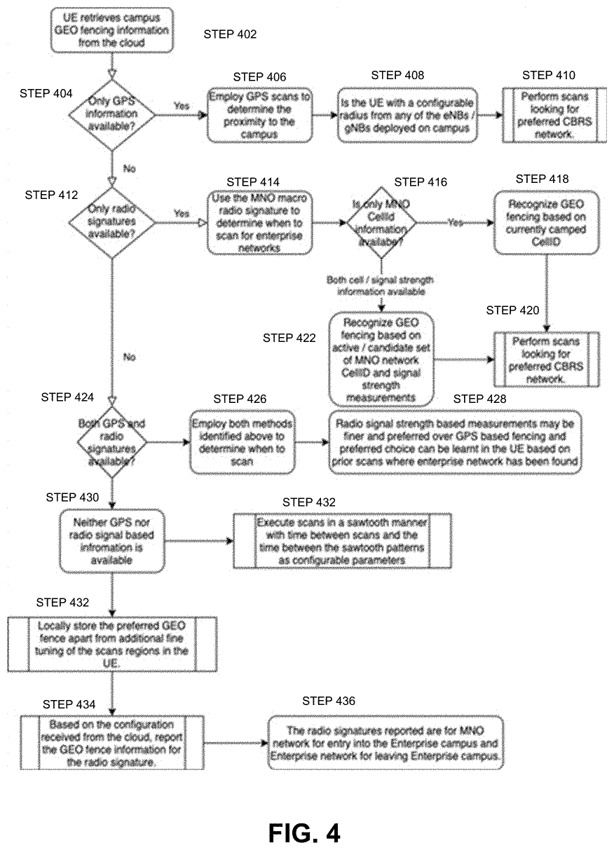

As described above with reference to FIG. 2, and FIGS. 4-7, inclusive, in some embodiments of the present method and apparatus, a selected UE (having credentials to communicate with and engage with a selected preferred EN) only starts engaging with the selected preferred EN when it is near the selected preferred EN campus. The selected UE may make a proximity determination, in some embodiments, based upon several different items of information. This information may include some or all of the following EN GEOFENCE information: radio signal characteristics (including LTE signal characteristics) obtained from the MNO BS/APs that are near the preferred EN campus; geographical shape information of the preferred EN, including degrees of uncertainty regarding the extremities of the shape information; GPS positioning data of the selected UE; etc. The selected UE uses this information to determine if it is sufficiently proximate the preferred EN's campus to start a scan for the preferred EN. The following section describes how the selected UE queries the cloud based database in order to obtain GEOFENCE information related to its preferred EN. In addition, a query to the UE's local memory is made in embodiments in which the EN GEOFENCE data is stored in UE local memory).

### QUERY FOR GEOFENCE INFORMATION

In some embodiments, a UE queries the cloud based database within the cloud based server 800 (see FIG. 8). The databased stores and maintains the preferred EN GEOFENCE data. In some embodiments, the EN GEOFENCE information is maintained in association with the enterprise NID described above with reference to FIG. 6 and/or the enterprise database high level schema described above with reference to FIG. 7.

In some embodiments, the UE's queries include the preferred enterprise NID and the current GPS location of the UE 102. As noted above, in some embodiments, only the NID of the UE's preferred EN is used to access a preferred EN's GEOFENCE data. In some embodiments, the cloud based database (or the UE's local memory) responds by providing a set of radio signal signatures associated with a closest EN campus (closest to the selected UE). That is, for each EN, there will be a set of radio signal signatures, or radio signal characteristics, that indicate the characteristics of the radio signals that can be received from MNO BS/APs 103 by a selected UE 102 when the selected UE 102 is located at various entry/exit points of the EN campus.

In some embodiments, the EN GEOFENCE information may include particular entry points that are typically “visited” by the users of the EN. In some embodiments, the radio signal signatures include associated weights used as a time series to determine entry and exit points of the EN campus. Position location information, in some embodiments, is provided to the UE 102 as a “center” point and set of GPS points along with radial distances identifying boundaries of a selected EN campus. In some embodiments, the center point is determined as an aggregate of a “trilateration” center of the campus, with a radial distance that is used to determine the EN campus boundaries. In other embodiments, the “center” of the campus can be determined using other means. In some embodiments, the position information includes a segment-linear boundary with a set of GPS points with straight lines connecting to each of a plurality of dots thereby marking the boundary of the EN campus. This approach is described above with reference to the geographical shape information of FIG. 5B, for example.

The UE 102 uses this information and run scans for the EN based on the radio signal signatures used as a static signature, the radio signal signatures used as a time series along with the weights provided. In some embodiments, GPS information is used if a radio signal signature is not available or if the UE 102 cannot be determined whether the UE is near an EN from the MNO network radio signal signature information. In some embodiments, if neither radio signal signature information nor GPS information is available, the UE 102 performs sawtooth based scans with a configurable timer set to determine the timing of sawtooth EN scans and also the time between initiating the sawtooth pattern.

### ENTERPRISE NETWORK APPARATUS

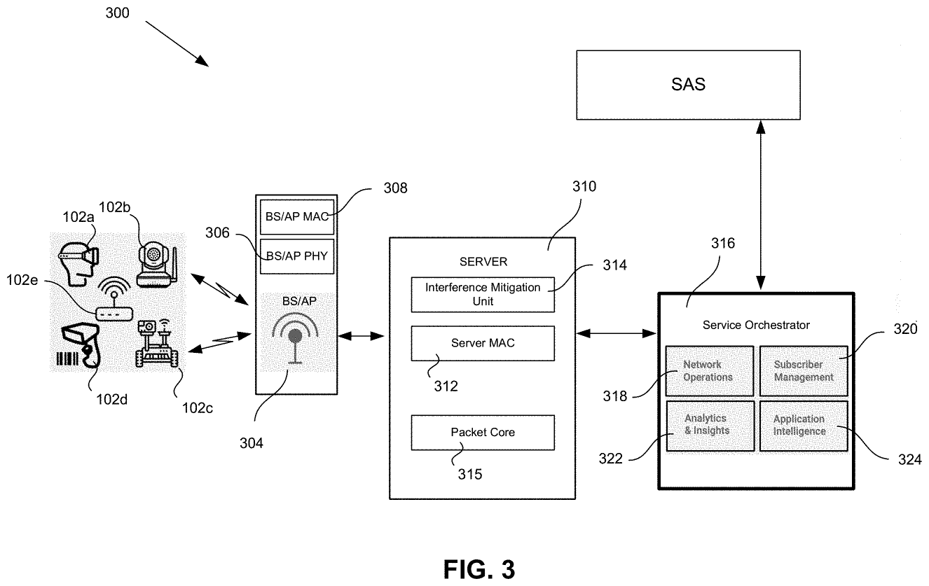

FIG. 3 is a simplified illustration of the apparatus used in some embodiments of the disclosed method and apparatus. In some embodiments the disclosed method and apparatus resides within the system 300. In one embodiment, the system 300 is part of an enterprise network (i.e., a private communications network). Authorized UEs 102 can connect wirelessly to an access point or base station (BS/AP) 103b of the enterprise network implemented by the system 300. In some embodiments, the BS/AP 103b is an eNodeB of an LTE/5G network, a Citizens Broadband Radio Service Device (CBSD) of a Citizens Broadband Radio Service (CBRS), access node of a local area network (LAN) or Wide Area Network (WAN), etc. It should be understood that these are just some the very large number of communication components that might be serviced/used in the private network implemented by the system 300.

Each of the UEs 102 has a transceiver that allows the device to communicate wirelessly with the BS/AP (103 in FIGS. 2 and 304 in FIG. 3). In some embodiments, UEs 102 include such devices as virtual reality googles 102a, robotic UEs 102b, autonomous driving machines 102c, smart barcode scanners 102d, and communications equipment 102e, which includes cell phones, computers and other types of personal communications devices. The BS/AP 103b (FIG. 2), 304 (FIG. 3) allows such communication to be extended to resources either within the private network implemented by the system 300 or with resources that are available in other networks, such as the internet, for example, through a gateway (not shown).

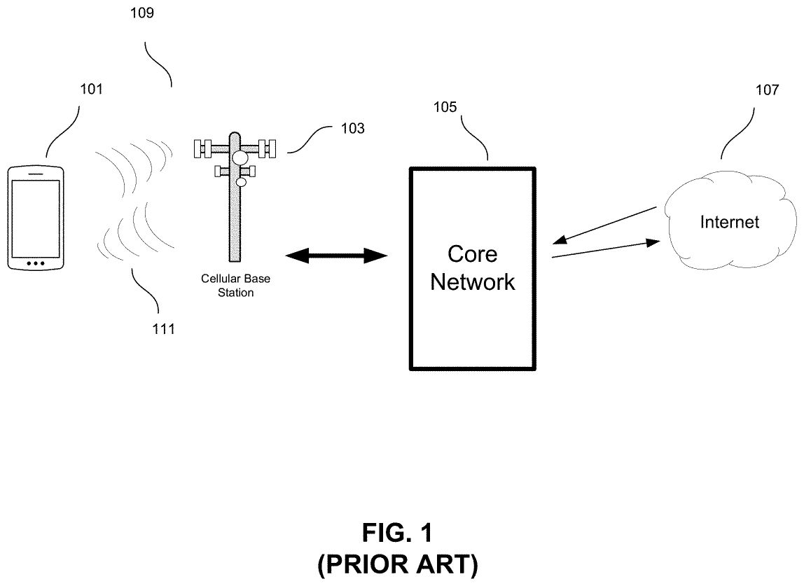

In some embodiments, the BS/AP (103b, FIG. 1; 304 FIG. 3) comprises a CBSD within a CBRS. In other embodiments, the BS/AP 103 is an access point, access node, eNodeB or base station operating at a frequency and in conformance with a protocol other than that of the CBRS. Accordingly, the BS/AP 103/304 may be a base station or central wireless communication hub within any wireless communication system. For the sake of describing the disclosed method and apparatus generally, the term BS/AP is used for all such communication nodes. In any case, in some embodiments, the BS/AP generally has a physical layer module (“PHY”) 306 (FIG. 3) and a Medium Access Control sub-layer module (“BS/AP MAC 308” (FIG. 3)). The PHY 306 performs functions associated with the PHY layer of the conventional 7-layer Open Systems Interconnect (OSI) model. The MAC 308 performs functions associated with the MAC sub-layer of a data link layer (“DLL”) of the OSI model.

In such embodiments, the PHY 306 is generally responsible for generating a transmission signal, propagating the signal and for receiving signals. Accordingly, components such as the amplifiers and filters are provided in the PHY 306. The MAC 308 is generally responsible for receiving content received by the PHY and controlling the physical hardware of the PHY 306. In particular, the MAC 308 determines the assignments of channels, the general organization of the signals to be transmitted, etc. In some cases, the MAC 306 may receive indications as to which channel to assign for transmission of a particular packet of content. However, the MAC determines the particular frequency used to transmit on that channel. It should be understood that this particular configuration is merely one example and the particular details of the organization of the radio within each of the components of the disclosed communication network are not of particular relevance to the disclosed method and apparatus, but are provided here merely as examples of one manner in which the system may be organized to assist in understanding one particular context in which the disclosed method and apparatus may be used. In addition, the designations and logical organization of functions within the radios of the components of the communications system can vary significantly without departing from nature of the disclosed method and apparatus.

A server 310 (which may also be referred to as an “edge compute platform”) is coupled to the BS/AP 304 over a separate connection from the wireless connection used for communication between the BS/AP 304 and the UEs 102. In some embodiments, the server 310 is coupled by a hardwire connection to the BS/AP 304, such as by a proprietary interface or over a standard interface, such as TR-069 on coaxial cable, ethernet cable, etc. In some embodiments, the BS/AP 304 is mounted on the ceiling within a facility, such as a room within an office building or a factory floor within a manufacturing facility. However, the particular environment in which the private network implemented by the system 300 is installed is not of particular relevance to the disclosed method and apparatus, but is provided merely as context to facilitate an understanding of the disclosed method and apparatus.

In some embodiments, MAC functionality can be distributed between the BS/AP MAC 308 and a server MAC 312 that resides within the server 310. In other embodiments, all of the MAC functionality may be implemented by the server 310. In some embodiments, an Interference Mitigation Unit (IMU) 314 resides within the server 310. The IMU 314 performs functions that lie outside the scope of the conventional functions performed by a conventional MAC and PHY. In some embodiments, the server 310 further comprises a Packet Core Unit (PCU) 315. In some such embodiments, the PCU 315 performs functions similar to those performed by an Evolved Packet Core (EPC) of a 4G LTE network or a 5G Core (5GC) of a 5G network.

In some embodiments, a Service Orchestrator (SO) 316 provides additional functionality. In some such embodiments, the SO 316 comprises one or more of the following units: (1) a Network Operations Unit 318; (2) a Subscriber Management Unit 320; (3) an Analytics & Insights Unit 322; and (4) an Application Intelligence Unit 324. As shown in FIG. 3, the Service Orchestrator 316 communicates with an SAS block.

### DETERMINING PROXIMATITY TO AN ENTERPRISE NETWORK

FIG. 4 is a flowchart of the process used by a UE in accordance with one embodiment of the disclosed method and apparatus. Initially, a UE retrieves EN campus GEOFENCING information from a database (STEP 402). In some embodiments, the database is maintained in a cloud based server. In other alternative embodiments, EN GEOFENCE information may be available in local memory on the UE. The EN GEOFENCE information may be “pushed” into the UE local memory in a manner set forth by network system designers. No matter where the EN GEOFENCE information is stored, if only GPS information is available (STEP 404) then the GPS information is used to determine the proximity of the UE to the EN campus (STEP 406). Next, a determination is made as to whether the UE 102 is within a configurable radius of a BS/AP 103b of the private network (STEP 408). That is, is the UE 102 in range of an EN BS/AP 103b. If so, then the UE 102 performs scans to look for the EN (STEP 410).

If information other than GPS information is available (STEP 404), then a determination is made to check whether radio signal signature information is available (STEP 412). If such radio signal signature information is available, then the UE 102 uses the radio signal signature information to determine when to scan for the private network (STEP 414). In addition, a determination is made as to whether only cell ID information is available (STEP 416). If so, then the UE 102 recognizes the GEOFENCING information based on the BS/AP 103b on which the UE 102 is currently camped (STEP 418). The UE 102 then performs scans to look for the preferred EN based on the information at hand (STEP 420). If additional information is available (STEP 416), then the UE 102 uses both the cell ID and signal strength information to identify the EN GEOFENCING (STEP 422). Upon determining that the UE 102 is inside the EN GEOFENCE, the UE 102 begins scanning for the preferred EN (STEP 420).

If both GPS and radio signatures are available (STEP 424), then both are employed to determine when to start scanning for the EN (STEP 426). In some embodiments, radio signal strength based measurements may be finer and preferred over GPS based fencing (STEP 428). The choice can be made based on UE learned behavior based on prior scans in which the preferred EN was found.

If neither GPS nor radio signature information is available (STEP 430), then scanning is performed based on a timing pattern, such as a sawtooth pattern (STEP 432). In addition, information regarding the GEOFENCING is stored in the database (STEP 434) to further refine the information available for later use by this or other UEs. In addition, radio signatures are reported for MNO networks for entry into the private campus and for exiting the private campus (STEP 436).

### AN ALTERNATIVE METHOD FOR DETERMINING PROXIMATE

In accordance with an alternative method for determining whether a selected UE is sufficiently proximate a selected EN campus to initiate a scan for the selected EN, the selected UE is initially provisioned to have the NID of the preferred EN (the EN that it has authorization to access) stored in its local memory. Stated differently, the selected UE “knows” which preferred EN it would like to access. This EN is identified by the unique NID for the EN. The selected UE also has information regarding the radio signal characteristics that the UE would receive from the MNO BS/APs when it is sufficiently proximate the preferred EN campus. In accordance with one embodiment of this method for determining whether the selected UE is sufficiently proximate the selected EN campus to initiate a scan for the selected EN, the selected UE frequently (if not constantly, in some embodiments) compares the radio signal characteristics stored in the database (or stored in the UE's local memory, or both) with the radio signal characteristics received from the MNO BS/APs that it is communicating with. The selected UE continues to compare this information to find a suitable match, within a predetermined threshold. When the UE finds a match (within the predetermined threshold) of radio signal characteristics received from the MNO BS/APs and those stored in the cloud based database (or stored in local UE memory, in some embodiments), it determines that it should start scanning for the preferred EN because it realizes that it is near the preferred EN to initiate a scan therefor.

In this scenario, it can be stated that the selected UE initiates its search using an MNO network coverage area (a relatively large coverage area), and narrows its search to the preferred EN coverage area. Once the UE determines it is sufficiently proximate to the preferred EN campus, within the predetermined threshold, it initiates its scan for the preferred EN.

Essentially the described alternative method can be described as having two main components: (1) the selected UE first determines whether or not it is near a preferred EN campus using the methods described above. Once a determination is made that the selected UE is near the preferred EN, (2) the selected UE initiates a scan for the preferred EN. In some embodiments, the selected UE will not “camp” on a preferred EN BS/AP until and unless it receives reference signal received power (RSRP) values that exceed a predetermined threshold. Stated differently, there is a predetermined threshold of RSRP values that a selected UE must receive before the selected UE camps onto a preferred EN BS/AP.

### CLOUD BASED SERVER

FIG. 8 shows a cloud based server 800 that can be used to practice the methods and apparatus in accordance with the present disclosure. As shown in FIG. 8, the cloud based server 800 includes a memory 801, a processor 803 and a transceiver 805. The processor 803 includes a UE Request Management processing block 807 and a Database Control Module 809. Selected UEs access the cloud based server 800 via the transceiver 805. In most embodiments, the selected UEs access the cloud based server 800 via a wireless RF link. The cloud based server 800, and specifically, the UE Request Management processor 803, and the database control module 809, work together to execute the above-described methods and apparatus related to EN GEOFENCING, and more specifically they work together to allow a selected UE to determine whether or not it is near a preferred EN to initiate a scan for the preferred EN. In one embodiment, the cloud based server 800 executes the method described above with reference to FIG. 4. It also can be used to execute the above-described alternative method for determining if a selected UE is sufficiently close to a preferred EN to initiate a scan for the preferred EN. Those skilled in the hardware and software processing arts shall understand how the cloud based server 800 functions to execute the methods described above.

The disclosed method and apparatus provides finer GEOFENCING data based on the radio frequency (RF) coverage provided by BS/APs 103 of both ENs and different MNO network coverage areas. In addition, the disclosed method and apparatus provides better marking of the individual campuses. In some embodiments, mapping of the EN GEOFENCE as disclosed provides more reliable EN GEOFENCING information, given that the actual RF signatures are used instead of using the GPS-based rough coverage of the different enterprise cells. In addition, the disclosed method and apparatus addresses the desire to have indoor lower-powered versus outdoor higher-powered coverage implicitly. In addition, the EN GEOFENCE data obtained using the present method and apparatus allows a UE to adapt to the MNO network to which the UE's has subscribed. Information regarding the coverage area of the various MNO networks can be used by private enterprise devices also, because information can be attained through the cloud based database, and uses one or more of the MNO network radio signatures to find and enter the EN campus even without having an MNO subscription. By triggering the UE based on information pushed to the UE, the UE avoids scanning for an EN when the UE is not yet in the EN coverage area. Nonetheless, the present method and apparatus provides for use of GPS location information opportunistically when available and/or when there is no MNO network coverage area to determine a current location of the UE. In addition, some embodiments of the disclosed method and apparatus support learning through crowd-sourcing to keep the EN GEOFENCE data up-to-date. In embodiments in which RF measurements can be performed during deployment to mark entry/exit points, this EN GEOFENCE information is stored in a database that is then primed with the relevant coverage areas.

Although the disclosed method and apparatus is described above in terms various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
a) querying a cloud based database;
b) receiving in response to the query, enterprise network location related information;
c) comparing the enterprise network location related information to a locally collected enterprise network location related information; and
d) if the received enterprise network location related information is a sufficient match to the collected enterprise network location related information, attempting to camp onto an enterprise network.

2. The method of claim 1, wherein the query includes the identity of the enterprise network.

3. The method of claim 2, wherein the received enterprise network location related information includes Cell-IDs expected to be received from MNO BS/APs by a UE near the identified enterprise network.

4. The method of claim 3, wherein the enterprise network location related information further includes power levels associated with the Cell-IDs.

5. A method of determining whether users are located within an enterprise network campus located within a coverage area of at least one Mobile Network Operator (MNO) networks, the MNO networks comprising at least one MNO BS/APs, the MNO BS/APs transmitting a Cell-ID, the method comprising:
a) storing within a database, at least one Cell-ID associated with an MNO BS/AP located near the enterprise network campus;
b) receiving a query from a UE having authorization to use the enterprise network;
c) in response to the query, providing the at least one Cell-ID.

6. The method of claim 5, further comprising:
a) storing information regarding the power level at which a UE near the enterprise network would receive a signal from the MNO BS/AP transmitting the Cell-ID; and
b) further in response to the query, providing the power level at which the UE near the enterprise network would receive a signal from the MNO BS/AP transmitting the Cell-ID.
